(19) United States
(12) Patent Application Publication
(10) Pub. No.: US 2025/0025728 A1
(43) Pub. Date: Jan. 23, 2025

(54) SLIP-RESISTANT YOGA MAT TILES AND RELATED METHODS

(71) Applicant: Neil WARD, Des Moines, IA (US)

(72) Inventor: Neil WARD, Des Moines, IA (US)

(21) Appl. No.: 18/780,216

(22) Filed: Jul. 22, 2024

Related U.S. Application Data
(60) Provisional application No. 63/528,279, filed on Jul. 21, 2023.

(51) Int. Cl. A63B 6/00; B32B 3/06; B32B 3/30; B32B 5/18

(52) U.S. Cl. CPC A63B 6/00; B32B 3/06; B32B 3/30; B32B 5/18; A63B 2209/10; B32B 2266/0278; B32B 2266/0292; B32B 2307/737; B32B 2307/744; B32B 2471/00

(57) ABSTRACT

The present invention relates to a kit of yoga tiles comprising a slip-resistant top surface, a slip-resistant bottom surface located opposite to the top surface, and a cushioned interior located between and integral with the top surface and the bottom surface that are capable of being customized for yoga practice. Another aspect of the invention relates to an assembly of two or more yoga tiles where the yoga tiles are no larger than about 150 inches in area making one or more tiles easy to transport, yet large enough to conduct yoga poses thereon. Another aspect of the present invention relates to methods of using yoga tiles, where the tiles can be customized to a user's desired configuration. Other advantages of the present invention relate to methods to using, cleaning, and transporting yoga tiles.

### CROSS-REFERENCE TO RELATED APPLICATIONS

The present application claims the benefit of priority to U.S. Provisional Patent Application No. 63/528,279, filed Jul. 21, 2023, entitled “SLIP-RESISTANT YOGA MAT TILES AND RELATED METHODS,” the entire disclosure of which is incorporated herein by reference in its entirety.

### BACKGROUND OF THE INVENTION

Yoga is a physical, mental, and spiritual practice from ancient India. Its modern form is used by many for physical fitness. It has a range of health benefits, and can help a practitioner relieve stress and relax. Modern yoga mostly consists of various poses and postures called asanas.

It is common for people to perspire during exercise. During yoga, this can cause difficulty when trying to maintain an asana, as the person's hands and feet may slide around on the floor or yoga mat. Aside from causing frustration or discomfort, the person may be injured if they slip unexpectedly. Yoga mats do not always have ways to prevent slippage. Additionally, conventional yoga mats are rectangular in shape, which requires being rolled up for transport and storage. Conventional yoga mats can be large and difficult to transport as they cannot always be stowed in a bag or similar carriable container. Regular mats can also be more difficult to store and clean because they may take up too much space even when rolled up.

### BRIEF DESCRIPTION OF THE INVENTION

One aspect of the present disclosure is a kit for a customizable yoga mat that includes a plurality of tiles, e.g. square-shaped, comprising: a slip resistant top surface, a slip resistant bottom surface, and a cushioned interior. The top surface is smooth and/or leathered to prevent a user's hands or feet that are in contact with the surface from slipping. The bottom surface is located opposite on the yoga square to the top surface and has a slip-resistant texture, for instance a rippled or ribbed texture, to prevent the yoga square from sliding on the ground. The cushioned interior is between the top surface and the bottom surface and is wear resistant. It also provides enough cushioning for a user in physical contact with it to be comfortable during standing or sitting poses. In certain embodiments, the cushioned interior may range in thickness between 1/16 inch to ½ inch. In at least one embodiment, the yoga mat is created using square, rectangular-shaped, or rounded tiles to create the desired configuration, although the configuration can be customized by the user.

Another aspect of the invention is a method of using yoga tiles that can be customized into a desired configuration to optimize the user experience. For instance, the user may select one or more locations on the floor or ground with which they expect to have contact and positions the yoga tiles in these locations. Once the yoga tiles are in the desired locations, the user may engage in yoga positions as normal, keeping their hands and feet on the yoga tiles. The user may also relocate the yoga tiles between positions. According to at least one embodiment, the yoga tiles are the same length on each side. In at least another embodiment, the yoga tiles are different lengths on each side.

### BRIEF DESCRIPTION OF THE DRAWINGS

FIG. 1 is a view of the bottom surface of a yoga tile.

FIG. 2 is a view of the top surface of a yoga tile.

FIG. 3 is an exploded view of the yoga tile.

FIG. 4 is a cross-section of the yoga tile with a cushioned interior, where the interior comprises one or more layers.

FIG. 5 is a perspective of the yoga tiles in a customized configuration, wherein the configuration is a square formation.

FIG. 6 is a perspective view of the yoga tiles in a customized configuration, wherein the configuration is a T-shaped formation.

### DETAILED DESCRIPTION OF THE INVENTION

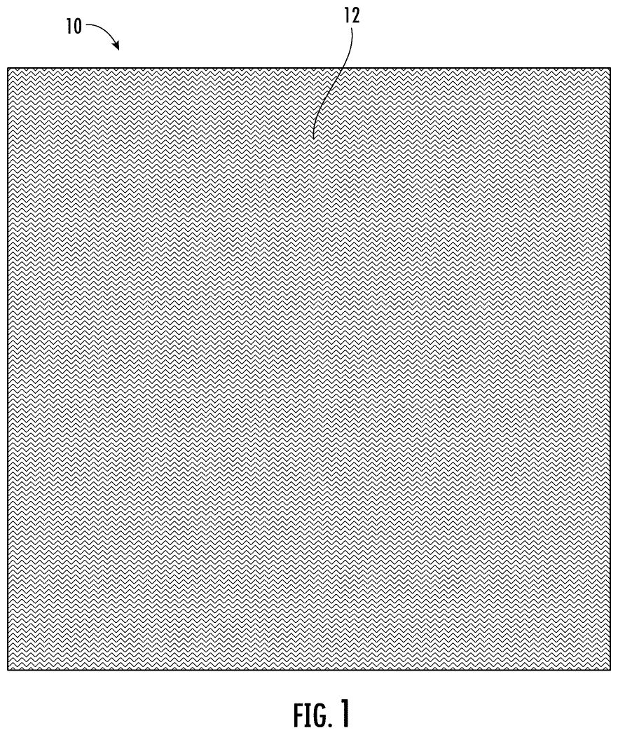

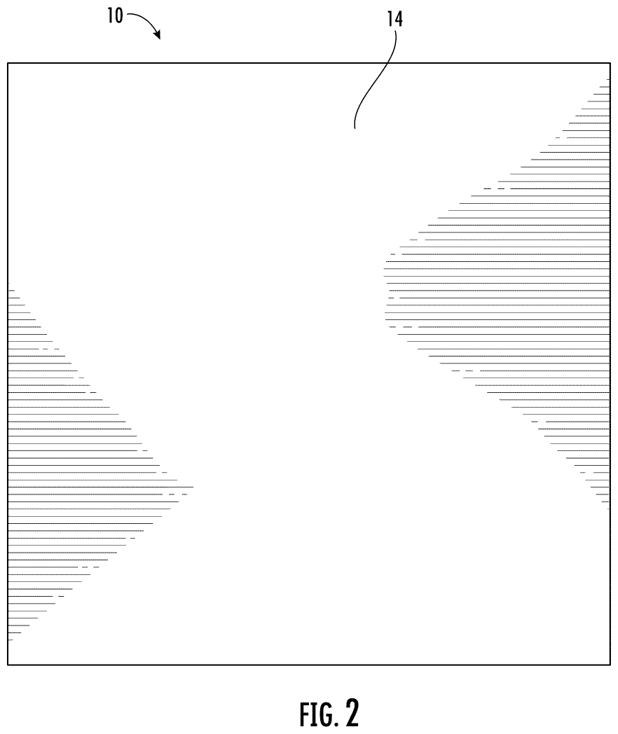

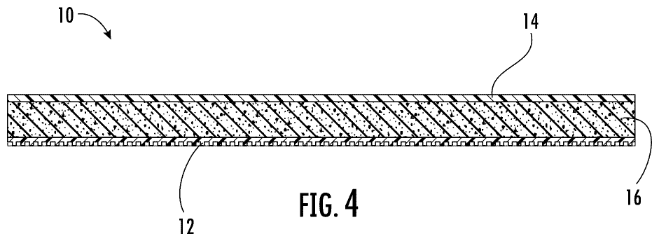

As seen in FIGS. 1-6, the yoga tile 10 of the present invention is a flat portion of a mat having a slip resistant top surface 14 that is typically smooth and a slip resistant bottom surface 12 that is rippled. The slip resistant top surface 14 is leathery and/or textured such that hands, feet, and other parts of the body will not slip on the mat. The slip resistant bottom surface 12 grips the floor/ground, and is prevented from slipping due to its texture. The texture on the slip resistant bottom surface 12 of the tile may be any texture that prevents the square from slipping or moving around on the floor or ground, while also not causing discomfort to the user. In one embodiment, the slip resistant bottom surface 12 of the tile is rippled. As used herein, “rippled” is defined as including one or more waves on the surface. The rippled or otherwise textured surface on the bottom of the mat. According to at least one embodiment, the tile is in the shape of a square or a rectangle. According to at least one embodiment, the tile is the same length on each side. According to another embodiment, the yoga tiles are different lengths on each side.

As will be appreciated by persons of ordinary skill in the art, during certain asanas, the yoga practitioner will often be supported by their limbs at an angle. During these positions, typical yoga mats can be subjected to a force that pushes them along the floor, often away from the user. Further, while on a typical yoga mat, the multiple corrective forces placed on the mat from the user's limbs help keep it in place. This, however, does not occur with a smaller mat which tends to slip. Thus, the slip resistant bottom surface 12 of the yoga square of the present invention helps to frictionally secure the mat to the floor, therefore preventing possible injury from losing balance and falling.

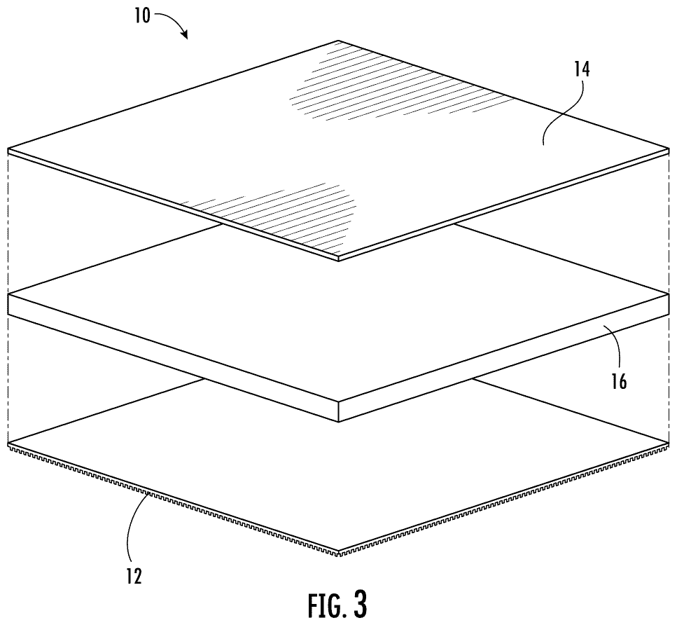

The kit and customizable yoga tiles 10 of the present invention have a cushioning interior layer 16 between the slip resistant top surface 14 and the slip resistant bottom surface 12 (FIG. 3). The cushioning interior layer 16 is firm such that the slip resistant bottom surface 12 and the slip resistant top surface 14 are not displaced horizontally relative to each other when pressure is applied from a user on the slip resistant top surface 14. The cushioning interior layer 16 is also is strong enough to avoid tearing with extended use. The cushioning interior layer 16 still provides enough cushioning so that the user does not feel discomfort will in certain asanas. Some asanas, such as the ashtanga namaskara and balasana, involve placing or balancing the user's head on the ground. As such, it is ideal in these scenarios for the surface to be cushioned and comfortable. In the event a use does lose balance and fall, the cushioning can help prevent injury to bodily areas contacted by the yoga tiles.

According to at least one embodiment, the yoga tiles 10 should be made of any material that is strong enough to resist wear from constant use, yet sufficiently cushioned to be comfortable for the user. The material should also be generally resistant to moisture and perspiration and easy to clean. Acceptable materials for this purpose include, but are not limited to, polyurethane and thermoplastic elastomer foam, although they could be made of any similar material known in the art.

In another aspect of the present invention, the yoga tiles 10 should be small enough for the user to easily store and transport, yet large enough to accommodate most user's hands and feet during yoga poses. The width and size may vary, but may generally range in length and width of from about 8-15 inches each, with about 9-12 inches in each length and width being typical. In one embodiment, the yoga tiles 10 are in the shape of a square, more particularly about 12 inches by 12 inches, or alternatively about 10 inches by 10 inches. Put another way, the yoga tiles 10 of the invention should be no more than about 150 inches in area, with about 64-144 inches being typical. In some embodiments, the area of the yoga tiles is about 80 square inches. In another embodiment, the area of the of the yoga tiles are about 100 square inches. In yet another embodiment, the yoga tiles have an area of about 140 square inches.

While the present invention is described as “yoga tiles 10” or “yoga squares” herein, it is to be understood that the yoga tiles may also be circular or rounded in shape (i.e. without corners), and therefore may also be round, circular or oval in shape, with a diameter also in the range of about 8-15 inches, with about 9-12 inches in diameter being typical. In some embodiments, the yoga tiles may be triangular, with each of the sides being the same length or having different lengths. It is also understood that the yoga tiles 10 of the invention may be rectangular in shape and are not required to be identical in height and width, the only restriction being that the yoga square must still be easy to transport and accommodate the user's hands and feet for typical yoga poses and positions.

Another advantage of the present invention relates to the versatility provided by the kit and yoga tiles 10 of the present invention, for instance the ability to carry the yoga tiles 10 in most bags, carry-ons, purses, duffle bags, or backpacks, allowing the yoga tiles 10 to be easily transported to wherever the user goes. This makes them useful for users who are on vacation or travel a lot, but still wish to practice yoga. The flat shape of the yoga square enables multiple yoga tiles 10 or yoga squares to be conveniently stacked on top of one another, while the texture makes them less likely to slide and consequently topple the stack when being transported or stored.

The size of the yoga tile 10 also enables easy cleaning. The yoga tiles 10 can be washed off in a sink or basin, or in certain embodiments the tiles may be washed in a washing machine. In contrast, commercially available yoga mats are cumbersome due to their size and can be challenging to wash and keep sanitized.

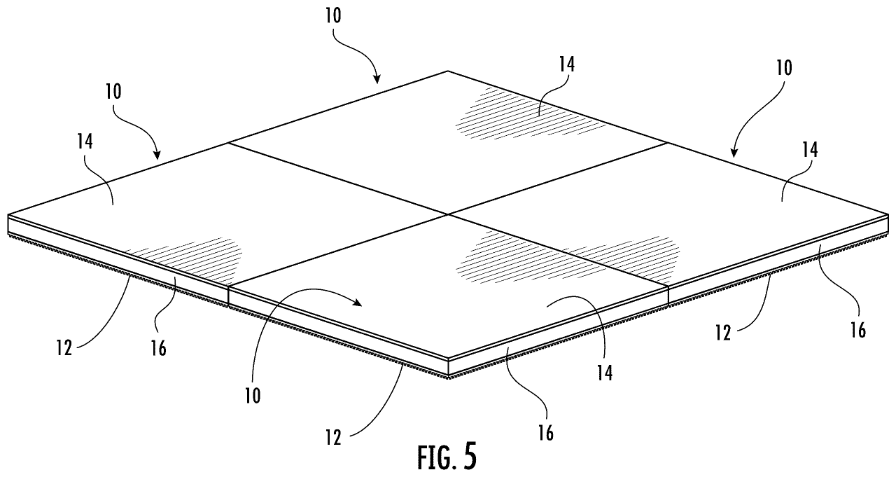

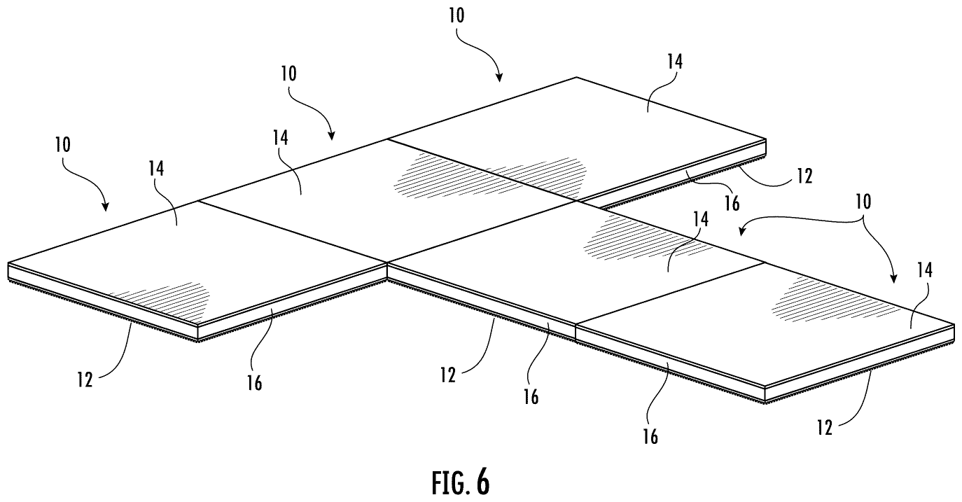

According to at least one embodiment of the present invention, a user could arrange a large number of yoga tiles 10 in a grid formation with the edges removably engaged with one another. In this fashion, a user can create a conventional, rectangular sized yoga mat comprising multiple yoga tiles 10. As shown in FIG. 5, the yoga tiles 10 can be arranged in a square formation. This provides the user with the benefits of a standard-sized yoga mat, but also allows a user to disassemble the yoga tiles 10 for easy transport, for instance in a gym bag or backpack, as well as storage in a gym locker. Any number of yoga tiles 10 can be arranged to fit the user's needs and specific purpose, for instance as depicted in FIG. 6. In certain embodiments, the present invention includes instructions, for instance instructions for using the yoga tiles 10, cleaning and/or handling the yoga tiles 10.

In another embodiment of the invention, the kit and yoga tiles 10 of the present invention include a connecting means to fasten to one another to create larger unitary surfaces. Such connecting means are well known in the art an may include, but are not limited to, hook and loop fasteners, zippers, snaps, etc. In another embodiment of the invention, the yoga tiles 10 may include female and male connecting portions or shapes on the ends of the squares such that the squares can interconnect like puzzle pieces. Any number of yoga tiles 10 can be fitted together to conform to the user's needs, size and specific use.

As persons of ordinary skill in the art will appreciate, while the yoga tiles 10 described herein are designed specifically for use with yoga, but the tiles may also be used for uses activities outside of yoga that employ a mat. For instance, the tiles may be used as a slip resistant surface or shower mat. The yoga tiles 10 could also be used, for example, under pet feeding bowls to prevent slippage and spillage, since cats and dogs often push their bowls around. The yoga squares could be used in any application where a small slip resistant surface would be desirable, for instance in a kitchen or when praying. Such potential uses may be readily ascertained by persons skilled in the art.

Another aspect of the present invention relates to methods of using the yoga tiles 10. For instance, to use the yoga tiles 10, a user will select locations on the floor/ground where they expect to have contact with during yoga positions. The user positions the yoga squares in these locations. If the user has a particular routine, they may set up the yoga tiles 10 in locations most optimal to their yoga practice. The user can also move the yoga tiles 10 as needed between asanas. Once the yoga tiles 10 are in the desired locations, the user may do yoga positions as normal, but with their hands and feet on the yoga tiles 10 without concern that they will slip or move around on the user. A typical yoga mat, consisting of a single piece of material, is about 68 to about 7s inches long and about 24 inches wide. In an embodiment where the yoga tiles 10 are sized at 12 by 12 inches or 10 by 10 inches, the user may arrange a number of yoga tiles 10 to approximate the shape and size of a typical yoga mat. Accordingly, the configuration of a plurality of yoga tiles may be 5 tiles×2 tiles, 6 tiles×2 tiles, 7 tiles×2 tiles or alternatively 6 tiles×3 tiles or 7 tiles×3 tiles. In alternative configurations, the tiles may be arranged in a T-shape or another shape that does not conform to a typical rectangle or square configuration, such as in FIG. 6.

All publications, patents and patent applications cited herein are incorporated herein by reference. While in the foregoing specification this invention has been described in relation to certain embodiments thereof, and many details have been set forth for purposes of illustration, it will be apparent to those skilled in the art that the invention is susceptible to additional embodiments and that certain of the details described herein may be varied considerably without departing from the basic principles of the invention.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A kit of yoga tiles comprising at least one yoga tile comprising:
a slip-resistant top surface;
a slip-resistant bottom surface located opposite to the slip-resistant top surface;
a cushioned interior located between and integral with the slip-resistant top surface and the slip-resistant bottom surface; and
wherein the at least one yoga tile being no larger than about 150 square inches in area.

2. The kit of yoga tiles of claim 1 wherein the slip-resistant top surface has a smooth slip resistant texture.

3. The kit of yoga tiles of claim 1 wherein the slip-resistant bottom surface has a slip resistant texture.

4. The kit of yoga tiles of claim 1 wherein the cushioned interior is comprised of polyurethane and thermoplastic elastomer foam.

5. The kit of yoga tiles of claim 1 wherein the at least one yoga tile is between about 64 and 144 inches in area.

6. The kit of yoga tiles of claim 1 wherein the at least one yoga tile is in the shape of a square.

7. The kit of yoga tiles of claim 1 that comprises a means for connecting at least one portion of the at least one yoga tile with at least one portion of a second tile.

8. The kit of yoga tiles of claim 7 wherein the means for connecting the at least one portion of the at least one yoga tile with at least one portion of the second tile is selected from one or more from the group consisting of hook and loop fasteners, zippers, snaps, and female and male interlocking components.

9. The kit of yoga tiles of claim 1 wherein the slip-resistant bottom surface has a rippled texture.

10. A method of using yoga tiles as a mat comprising:
placing a first yoga tile in accordance with claim 1 on ground corresponding to areas where the user's hands, feet, and other body parts will contact the ground, and
placing a second yoga tile adjacent to the first yoga tile; and
executing yoga positions on the mat.

11. The method of claim 10 further including the step of connecting the first yoga tile with at least one adjacent yoga tile.

12. The method of claim 11 wherein the first yoga tile is capable of being connected by a connecting device selected from one or more from the group consisting of hook and loop fasteners, zippers, snaps, and female and male interlocking components.

13. The method of claim 11 wherein the first yoga tile and the second yoga tile are between about 64 and 144 square inches in area.

14. The method of claim 11 wherein the first yoga tile and the second yoga tile are in the shape of a square.

15. The method of claim 11 wherein the first yoga tile and the second yoga tile further comprise a means for connecting at least one portion of the first yoga tile with at least one portion of a second yoga tile.

16. A method of manufacturing a yoga mat in accordance with claim 1 comprising:
assembling one or more tiles to a desired configuration, wherein the one or more tiles comprise a slip-resistant top surface and a slip-resistant bottom surface around a cushioned interior;
wherein the one or more tiles are no larger than about 150 square inches in area.

17. The method of claim 16 wherein the one or more tiles is between about 64 and 144 square inches in area.

18. The method of claim 16 wherein the one or more tiles is in the shape of a square, rectangle, oval, or circle.

19. The method of claim 16 wherein the one or more tiles further comprises a means for connecting at least one portion of a first tile of the one or more tiles with at least one portion of a second tile of the one or more tiles.

20. The method of claim 16 wherein the bottom surface of the one or more tiles has a rippled texture.
